(19) United States
(12) Patent Application Publication
(10) Pub. No.: US 2003/0030542 A1
(43) Pub. Date: Feb. 13, 2003

(54) PDA security system

(76) Inventor: Gerard von Hoffmann, Trabuco Canyon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/928,078

(22) Filed: Aug. 10, 2001

(51) Int. Cl. G05B 19/00

(52) U.S. Cl. 340/5.61; 711/150; 713/200

(57) ABSTRACT

Disclosed is a personalized security system for use with a PDA or other portable electronic device. An interrogator signal is transmitted from the portable electronic device, triggering a responsive transmission of a password from an electronic key carried by the wearer. Certain selected functions or all functions of the electronic device are therefore only enabled if the electronic device is within a predetermined operating proximity of the electronic key. Also disclosed is a personal preference monitoring system, for allowing personal preferences to be automatically implemented in response to a user passing within a predetermined distance of an interrogation signal transmitter.

### BACKGROUND OF THE INVENTION

The present invention relates to security systems for electronic devices, such as cellular telephones, PDA's, personal computers, and the like. More particularly, the present invention relates to an electronic key system that only enables all or selected functions of an electronic device when in proximity to an authorized user.

Personal digital assistants (PDA's) currently provide a wide variety of productivity applications, such as a calendar, an address book, notes and memos, and an extensive memory in a convenient, hand held form. One of the most popular current PDA's is the Palm Pilot, manufactured by 3Com Corporation. PDA's also provide certain telecommunications functions through the use of a separate modem. Such modem may be an external device, as in the case of the Palm Pilot, a built in software modem as in the case of some palm size PCs, or it may be an internal PC card, as in the case of the Apple Newton, manufactured by Apple Computer Corporation. The telecommunications functions provided by a PDA when operated in conjunction with a modem can include the sending and receiving of email and access to computer networks, such as the Internet.

PDA designs have recently been improved to incorporate a number of features previously found only in traditional laptop or desk top computers. For example, many recent PDAs have touch sensitive screens that allow a user to quickly and efficiently enter information by touching a stylus to the screen. The PDAs may employ a user friendly graphical user interface such as a Windows® or Windows® CE interface. In addition, the user may write messages directly on the screen using the stylus. The image produced may be transmitted via electronic mail or facsimile or may simply be stored in memory. With the advances in handwriting recognition, the PDA can interpret the writing and convert it into a text format.

Various types of input/output devices are being developed to facilitate the transfer of information involving existing data on external media to the PDA. For example, optical scanners, memory cards such as PCMCIA cards, infrared transceivers, cables and some telecommunication techniques have been used to transfer information between the PDA and other sources. These various techniques allow the user to easily transfer data to and from the PDA in a mobile environment.

Many PDAs are linked to Global Positioning Satellite (GPS) systems allowing the PDA to provide the user with a geographical location. Further, the PDA can provide information such as traveling directions if the PDA contains street information such as an electronic map.

Although inconsistent with common usage, except where used differently herein, the present inventor intends the term PDA to generally include any of a wide variety of personal electronic devices such as handheld computers conventional PDA's and cellular telephones. Although currently discrete devices, all of these devices will hopefully evolve into a simple, handheld, multi-functional unit.

PDA's will thus likely continue to develop increasingly complex capabilities. PDA users will predictably develop greater reliance on their PDA for storing increasing amounts of highly sensitive information, including passwords, account numbers, confidential notes and scheduling information. Unfortunately, that information is readily available to whoever has possession of the PDA. In systems which require a password for access, the user must remember the password, and take the time to enter it, often on a suboptimal keyboard, and await verification, each time the device is turned on. Thus, despite the rapid advance of PDA capabilities, there remains a need for a security system that ensures that the device can only be utilized by the intended operator.

### SUMMARY OF THE INVENTION

There is provided in accordance with one aspect of the present invention, a method of enabling a portable electronic device. The method comprises the steps of transmitting an interrogation signal from the electronic device, and receiving the interrogation signal at an electronic key which is remote from the device. A password is transmitted from the key in response to receipt of the interrogation signal, and at least a portion of the functionality of the electronic device is enabled in response to receipt of the password. The device may comprise any of a variety of handheld electronic devices, such as PDAs, cellular telephones, and portable computers. In one embodiment, the interrogation signal comprises an RF signal, and the password comprises a modified form of the interrogation signal. The key comprises a passive or active RF-ID circuit.

In accordance with another aspect of the present invention, there is provided a portable electronic device security system. The system comprises a portable electronic device, having an interrogation signal transmitter associated therewith. An electronic key is provided remote from the device, having a password encoded within the key. The key transmits the password in response to an interrogation signal from the device, and at least a portion of the functionality of the device is enabled in response to receipt of the password. The key is provided with a support structure, for supporting the key on or by the user, apart from the electronic device. The support structure may comprise a tag, for attachment to an article of clothing, a wristband, a wristwatch, a wristwatch strap, belt clip, a pair of eyeglasses, a ring, a glove, or any of a variety of other personal items.

In accordance with a further aspect of the present invention, there is provided a wireless personal preference control system. The system comprises an RFID circuit including an antenna, a memory and at least one preference password therein. A receiver is provided remote from the RFID, and electronics in communication with the receiver are provided for identifying the password and executing a preference in response to receipt of the password by the receiver.

In one embodiment, the preference password may be modified or supplemented by the user. When the user passes within a predetermined operating range from the receiver, one or more passwords are retrieved from the RFID by the receiver, thereby enabling implementation of the preselected preferences. These preferences may include any of a variety of environmental conditions, such as selection of air conditioning, heating, music, or other aspects within a room. Alternatively, preferences such as computer log-on passwords, drawer locks, ergonometric relationships, lighting or other features of a computer workstation may be automatically established for a unique user in response to that user entering the area of the work station.

Further features and advantages of the present invention will become apparent to those of ordinary skill in the art in view of the detailed description of preferred embodiments which follows, when considered together with the attached drawings and claims.

### BRIEF DESCRIPTION OF THE DRAWINGS

FIG. 1 is a simplified block diagram of a personal security system or preference control system in accordance with the present invention.

FIG. 2 is a further block diagram of a security or preference control system in accordance with the present invention.

FIG. 3 is a perspective view of an RF-Key label which may be used in implementing the system of the present invention.

FIG. 4 is an exploded perspective view of the label of FIG. 3.

FIG. 5 is a partial perspective view of the label of FIG. 3, showing the first four layers.

FIG. 6 is a cut away perspective view of the label of FIG. 3; and

FIG. 7 is a sectional view of the label of FIG. 3, along the lines 7-7.

### DETAILED DESCRIPTION OF THE PREFERRED EMBODIMENT

In one application of the present invention, there is provided a security system for an electronic device. Although the security system may be utilized on relatively immobile electronic or electrically controlled devices, such as desk top computers, electrical equipment, motor vehicles, machinery, assembly or work stations and the like, the value of the present invention may be optimized in connection with providing security for mobile electronic devices. In another aspect of the invention, there is provided a personal preference coordinator, for communicating preset personal preferences from a memory device associated with a user, to external electronic devices in the user's surrounding environment.

The electronic security system provides a wireless method of enabling handheld electronic equipment only when in the hands of or immediate vicinity of an authorized user, and disabling the electronic equipment when access or operation is attempted by someone other than an authorized user.

This security system may find particular application for devices such as personal digital assistants (PDA's, cellular telephones, and other devices) in which the value of the content and insuring its security often vastly exceeds the value of the hardware. The basic system thus includes an electronic device for which personal security is desired, on-board circuitry for transmitting an interrogation signal and receiving a return password from a remote electronic key, and the remote electronic key. These features will be described in greater detail below.

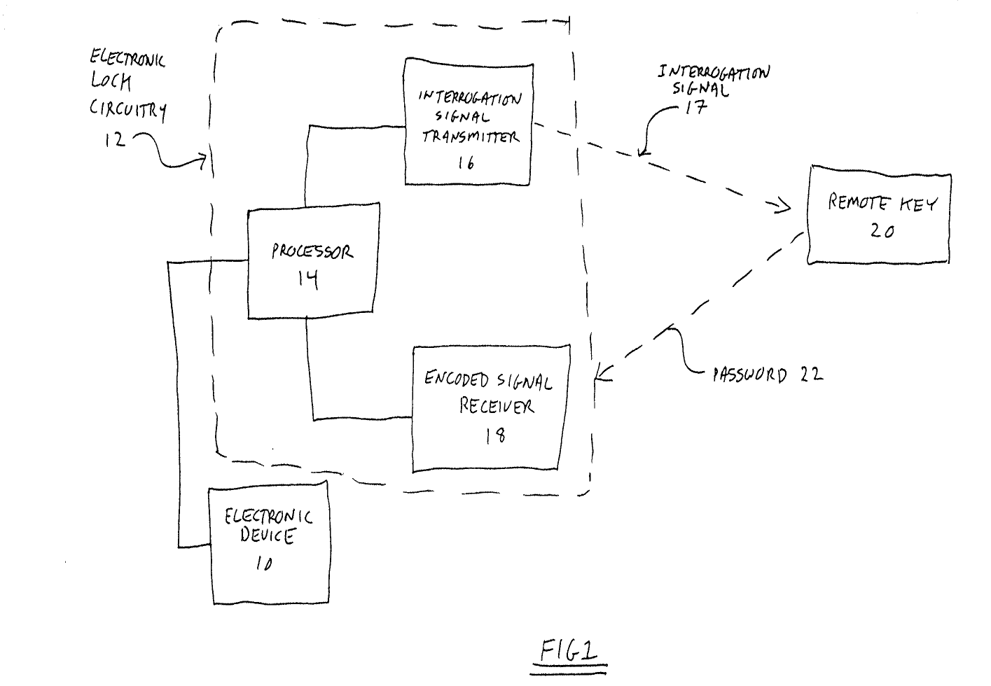

Referring to FIG. 1, there is illustrated a block diagram which, in schematic form, illustrates the basic components of a security system in accordance with the present invention. An electronic device 10 is provided with wireless electronic lock circuitry 12. The wireless electronic lock circuitry can be built into the original electronic device 10 at the point of manufacture, or can be mounted as an after market accessory to be attached to the electronic device 10 in any of a variety of ways depending upon the housing, electronic configuration and available communication ports of electronic device 10.

The wireless electronic lock circuitry 12 includes a computer or other processor 14 having a memory therein. The computer 14 is in electrical communication with an interrogation signal transmitter 16. A signal receiver 18 is also provided, which may include the same antenna and other overlapping components as the interrogation signal transmitter 16 as is understood in the art. The signal receiver 18 is in electrical communication with the computer 14, for interpreting the signal received.

A remote key 20 is adapted to be carried by an authorized user, as is discussed below. The remote key 20 is configurated to receive an interrogation signal from the interrogation signal transmitter 16, and transmit a password 22 in response to receipt of the interrogation signal. As used herein, “key” and “RF-Key” are used interchangeably. Although the presently preferred embodiment utilizes an RF signal, the invention is not limited to a particular communication modality. Other wireless means for communicating a password may also be used, such as light, including IR, UV or visible from a laser or other source. Acoustic and electrostatic communication may also be used.

In one embodiment, the interrogation signal and responsive password are transmitted through the body of the user. This mode of password communication may be desirable in applications where the user is required or it is convenient for the user to physically touch a surface to allow signal transmission. In this implementation, a conductive surface on the remote key 20 is in capacitative communication with the user's body at a first location, (e.g., the foot, hand, arm, abdomen, etc.) and the device 10 is provided with a surface for communicating with the user's body at a second location such as the hand in which the device is held during normal operation. Capacitative coupling to transmit data through a user's body is disclosed, for example, in U.S. Pat. No. 6,211,799, the disclosure of which is incorporated in its entirety herein by reference.

The password 22 is received by the signal receiver 18, and processed by the computer 14 to identify whether the password 22 is authorized for use on the security system. If the password 22 is authorized, the computer unlocks the electronic device 10 either wholly or partially, such as by enabling power to the electronic device and/or enabling the operation of one or more features on the electronic device which were subject to the security system. In one preferred implementation of the present invention, the electronic device comprises any of a variety of handheld electronic devices which contain memory or functions which are desired to be kept confidential. These include devices such as cellular telephones, PDA's, notebook, laptop and desk top computers, and others as will be apparent to those of skill in the art in view of the disclosure herein.

The processor 14 can control operation of the device 10 in any of a variety of ways, as will be understood by those of skill in the art. For example, through a simple transistor switch or other known circuitry, the processor can open or close the power circuit within the device 10. In one operating mode, the “normal” power on button for the device 10 is depressed, sending power to the interrogating signal transmitter 16 which instantly transmits an interrogation signal 17. If an RF-Key is within range, and sends back an authorized password, the switch is closed by controller 29 thereby powering on the device 10. A known latch circuit can be utilized, to maintain the power circuit closed, until the power for the device 10 is manually turned off. If no appropriate password is received while the power button is depressed, the switch controlled by controller 29 remains open thereby preventing the device 10 from powering on.

In a further option, the transmitter 16 is programmed to retransmit the interrogation signal at least one additional time following activation of the device. If the authorized RF-Key is no longer within range, the device 10 and/or specified secure functions are disabled. The retransmission can occur periodically, such as at least once every 10 minutes or more, at least once every 5 minutes or at least once per minute, to ensure that the device will automatically be disabled once it leaves the proximity of the authorized user The security system can be used to enable or disable all or only some of the functions of the device 10. Partial enablement requires a more complex integration between the controller 29 and the device 10, but should be well within the level of ordinary skill in the art. For example, one or more functions on a PDA such as the memo pad or telephone list may be enabled in the presence of an RF-Key and disabled if outside of the read range from the corresponding RF-Key. An unauthorized user e., someone without the unique RF-Key which contains the enabling password) can operate all functions on the PDA except the memo pad, telephone list or other secure functions.

Although the RF-Key security system of the present invention is not immune from breach by a skilled “hacker”, the probability that the typical PDA thief could gain access to secure data should be quite low. For example, a typical passive RF-Key will reserve 39 bits of memory for the password code. That translates to about 550 billion possible unique codes.

The RF-Key 20 is preferably in the form of a small, concealable device which may be carried by the user apart from the electronic device 10. The RF-Key 20 may take the form of a patch or tag having appropriate electronic circuitry contained therein, as will be described below. This RF-Key 20 may be concealed in or attached to a wrist watch or wrist watch band, wallet, eyeglasses, belt, key chain, gloves, pen or pencil, or any of a variety of other portable devices which a person who desires security would likely carry. The RF-Key 20 may be attached to clothing such as by clipping, pinning, stitching, and the like, or may be worn as a hang tag on a wrist band or neck chain, or placed in a wallet or pocket. It can be in the form of a flexible patch which is adhesively adhered to the skin like a small Band-Aid. It can also be concealed in jewelry, such as rings, bracelets, earrings, necklaces, pins and the like.

In use, the interrogation signal transmitter 16 and RF-Key 20 must be within a predetermined operating distance (read range) of each other in order for the RF-Key 20 to transmit a password 22 in response to an interrogation signal 17 from the interrogation signal transmitter 16. The operating distance will be a relatively short personal space distance, such that once the electronic device 10 is carried outside of the operating distance from the RF-Key 20, the electronic device 10 will be fully or partially disabled.

For most applications, operating distances of no more than about six feet, and often no more than about three feet may be used. Read ranges for certain passive RF-Key systems useful in the present invention, such as for PDA'S, are less than two feet and often in the range of from about six inches to about 18 inches

In a preference control circuitry application, the wireless electronic lock circuitry 12 may be attached to a land based structure or device, such as mounted on a wall, in a door frame, ceiling, computer work station, assembly line or other work station, in an automobile, or other location where a user is likely to reside or pass by. The wireless electronic lock circuitry 12 is then utilized to enable or adjust to a preference any of a variety of functions, such as environmental controls or electronic device preferences which are preset by the user. Thus, the user who carries an RF-Key 20 which has been preprogrammed with the user's preferences will pass within a predetermined distance of at least an antenna portion of the wireless electronic lock circuitry 12, and thereby enable the electronic device 10 in accordance with the predetermined preference. These preferences may include opening automatic doors, unlocking locks, adjusting lighting, adjusting environmental features such as temperatures or humidity, selecting musical preferences, adjusting mechanical preferences such as car seat heights, positions of mirrors, customization of workstation ergonomics such as chair adjustments, arm rests, mouse pad angles, carpal tunnel syndrome pads, monitor and keyboard locations, adjustment of equipment such as manufacturing or testing devices, selecting airline preferences such as meal and movie choices and the like.

Alternatively, the preference control circuitry may be utilized to power on or off any of a variety of electronic equipment such as computers, personalized content management on web sites or search engines, operation of ATM machines, testing or manufacturing machines and the like. Thus, although the present invention will be primarily described below in connection with the application of an RF-Key 20 for enabling wireless electronic devices such as PDA's and cell phones when in the hands of the holder of the RF-Key 20, the security or preference setting system of the present invention may be utilized in a variety of additional contexts as will be apparent to those of skill in the art in view of the disclosure herein.

When used in the preference control embodiment, the system of the present invention will often control more than one preference, such as two or four or six or more preferences. For example, in the environment of a computer workstation, the RF-Key may be programmed with a particular user's computer log on name, password, one or more adjustments to the physical configuration of the workstation (monitor height relative to chair height, keyboard orientation, lighting, music, etc.) or other features that might be adjusted between users of the same station.

The RF-Key may be provided with a plurality of electric contacts which may be removably placed in electrical communication with a programming computer, such as by positioning the RF-Key within a cradle or slot wired to a computer. Software then prompts the user to select from an array of available preferences displayed on the monitor, and then send the users selection of preferences to the RF-Key. In this manner, the user can customize the preferences stored in the RF-Key as may be desired from time to time, such that the most recently selected preferences will be expressed when the user moves into proximity of the interrogation signal transmitter (and thus the work station or other enabled location).

In a preference control application, the passive or active RF-Key can readily be built directly into a PDA, cell phone or other device that the user is likely to carry such as any of those identified above. If built into the cell phone or PDA, for example, the preferences can be set directly on the PDA keypad, or on a personal computer and then downloaded into the PDA through a HotSync connection as is known in the art. The PDA then essentially becomes an automatic remote control for setting personal preferences on any of a wide variety of preference enabled devices, examples of which are listed elsewhere herein, which the user might encounter throughout the day.

In another application of the invention, the system can be used to enable access or functions remotely in a secure, on demand fashion. For example, a worker or other person in a building or out in the field may require access to a locked door or device to which that person does not routinely need access or is otherwise restricted from routine use. That person can call from an enabled cell phone to a controller. If access is deemed appropriate, the controller can remotely program the Key in the cell phone with the access code, which will now provide access when the person (carrying the cell phone) moves within the operating distance from the device to be enabled. The cell phone can be either permanently or temporarily (e.g., one time use, weekly or monthly “pass”) enabled, in the discretion of the controller. This allows the controller to provide access without revealing the password, and also allows computerized tracking of who had access to secure functions or locations at any time. Creation of software for this and other applications disclosed herein should be well within the level of ordinary skill in the art in view of the disclosure herein.

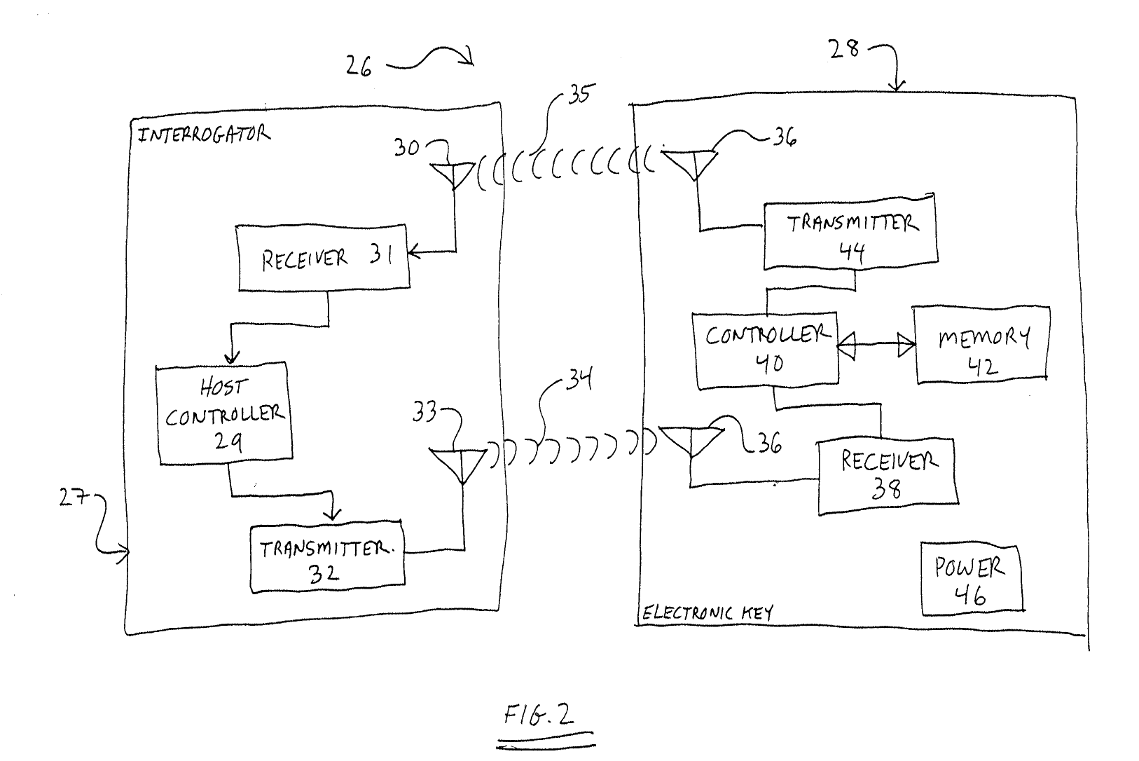

Certain additional aspects of a simple RF-Key system in accordance with the present invention will be appreciated by reference to FIG. 2. As illustrated therein, an RF-Key tag will generally have a radio frequency (RF) transmitter, an RF receiver, an RF modulator, and a memory. The memory retains the digital code manifesting the identification number. The RF modulator extracts the digital code representing the identification number as a modulated signal which is applied to the RF transmitter. The RF receiver receives interrogation and control signals which manifest a request for the identification number.

Referring to FIG. 2 the RF-Key communication system 26 includes an interrogator 27 and an RF-Key tag 28. The interrogator 27 includes a host controller 29 to process received information from the RF-Key tag 28 via antenna 30 and receiver 31. To retrieve information from the RF-Key tag 28, the host controller 29 generates an interrogation command signal which is transmitted by transmitter 32 and antenna 33 as signal 34. The tag 28 transmits RF-Key signal 35 via antenna 36 in response to receipt of the interrogation command signal 34. The receiver 31 receives the signal 35 via antenna 30. The signal 35 manifests the identification number of the tag 28.

The RF-Key tag 28 has an antenna 36 and a receiver 38 to receive the interrogation command signal 34 from the interrogator 27. The receiver 38 transfers the received command signal to a controller 40. The controller 40 interprets the command and extract the corresponding identification number (ID) from memory 42. The extracted identification number is then transferred by the controller 40 to transmitter 44 which transmits the ID to antenna 36 which broadcasts the signal 35.

In active RF-Key tags, power 46 is provided by a battery system. In passive systems, the power is induced from the received signal. The signal 35 transmitted by the RF-Key tag 28 is modulated back scatter of the original signal transmitted by the interrogator 27.

The controller 40 may have an interface, not shown, to receive data from external transponders such as temperature sensors, pressure sensors, global positioning sensing and other telemetric measurement data.

When multiple RF-Key tags 28 are simultaneously in close proximity to the interrogator 27 and the interrogator 27 is broadcasting interrogation and control signals, the RF-Key tags may simultaneously respond. The responses may collide and the identification codes may be garbled and lost. Generally, the interrogator will rebroadcast commands to establish an order of broadcast of the RF-Key tags. This ordering of the broadcast is generally possible only from active RF-Key tags.

A variety of circuits are known, which can be adapted by those of skill in the art for use in the security systems or preference control systems of the present invention. For example, U.S. Pat. No. 5,479,160 to Koelle, incorporated by reference herein, discloses an inexpensive circuit that consumes low power, can detect low level RF signal and RF signals of varying strength, and can reject intermittent low level RF interference. Logic circuitry is provided to insure that the read/write circuitry of the tag will not be activated unless the polarity of the reactivation signal is detected for a specified time.

U.S. Pat. No. 5,541,604 to Meier, incorporated by reference herein, discloses the use of a single set of circuitry in each of the interrogator and the transponder for transmission and reception of both powering and communication signals, without the need for synchronization between interrogators. PWM (pulse width modulation), PPM (pulse position modulation) and FSK (frequency shift keying) transmission systems are disclosed.

U.S. Pat. No. 5,485,154 to Brooks et al, incorporated by reference herein, discloses systems and methods of communicating with or identifying more than one remote device employing random sequence selection of a carrier signal frequency from a defined set of carrier frequencies. The remote device selects a carrier signal frequency and transmits data such as an identification code using that frequency and then reselects the same or a new carrier signal frequency for the next transmission event.

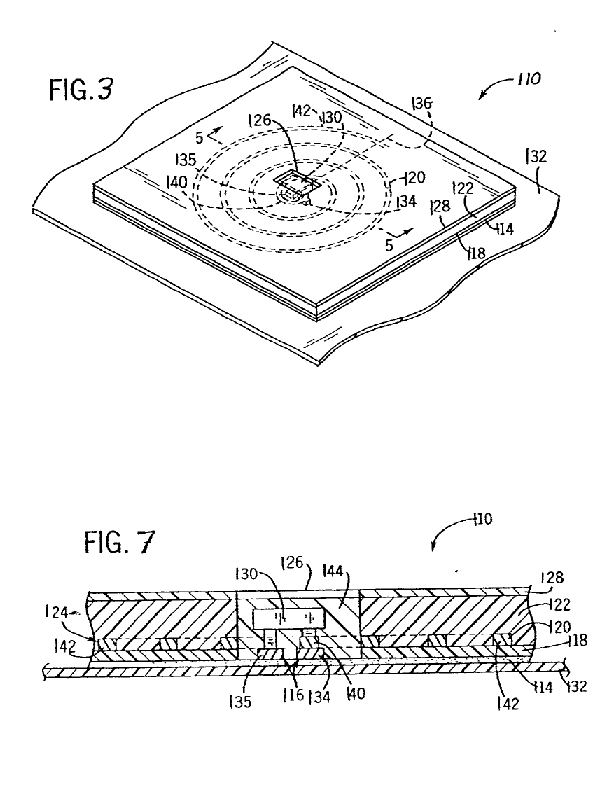

The RF-Key tag can be manufactured in any of a variety of ways, as will be recognized by those of skill in the art. One example of a low profile, laminated RF-Key is discussed in connection with FIGS. 3-7, below.

Referring to FIGS. 3, 4, and 7, a laminated RF-Key label 110 has five layers 114, 116, 118, 120, and 122, and forms a protective cavity 126 for RF-Key circuitry in the form of an IC chip 130. One of the layers 122 defines the cavity 126 for the IC chip 130, which is electrically connected to an antenna 124. The label 110 may be encapsulated or receive additional protective or functional layers 128 suitable for specific applications.

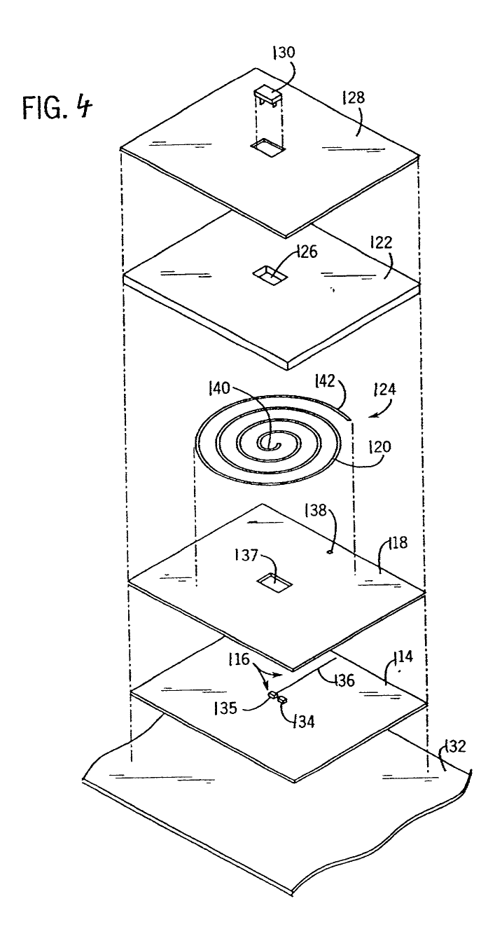

Referring to FIGS. 4 and 7, the first layer 114 is an adhesive material which is deposited on a release liner 132. The release liner is preferably a silicone coated paper. However, any of a variety of liners having releasable properties may be used. By forming the label 110 on the release liner 132, a substrate is not required, thus reducing the cost of the label 110.

The adhesive first layer 114 may be a UV curable pressure sensitive adhesive, such as Acheson ML25251 available from Acheson Colloids Company, Port Huron, Mich. This layer 114 provides an adhesive surface for the finished label 110 and defines the boundary of the label area of the generally rectangular label 110.

Although the label 110 described herein is generally rectangular, the label 110 may be any shape without departing from the scope of the present invention. In general, the shape of the label will be influenced by the intended location of the final, mounted RF-Key device.

The second layer 116 is an electrically conductive material which is selectively deposited onto the first layer 114. It may be formed of a metallic conductive ink, such as Acheson Electrodag® 479SS available from Acheson Colloids Company, Port Huron, Mich. The second layer 116 may be deposited using silk screening, or other methods known in the art for depositing an electrically conductive material, such as electro deposition, hot stamping, etching or the like.

As shown best in FIG. 4, the electrically conductive material 116 is deposited onto portions of the first layer 114 defining at least two landing pads 134,135 for IC chip attachment and a cross over pass 136. The landing pads 134 provide electrical attachment pads for electrically connecting the fourth layer 120 to the IC chip 130. As more clearly described below, in cooperation with the third layer 118, the cross over pass 136 electrically connects one of the landing pads 134 to a portion of the antenna 124 without shorting out other antenna portions. Although two landing pads 134, 135 are described herein, more than two landing pads 134, 135 may be formed for connecting to the IC chip 130.

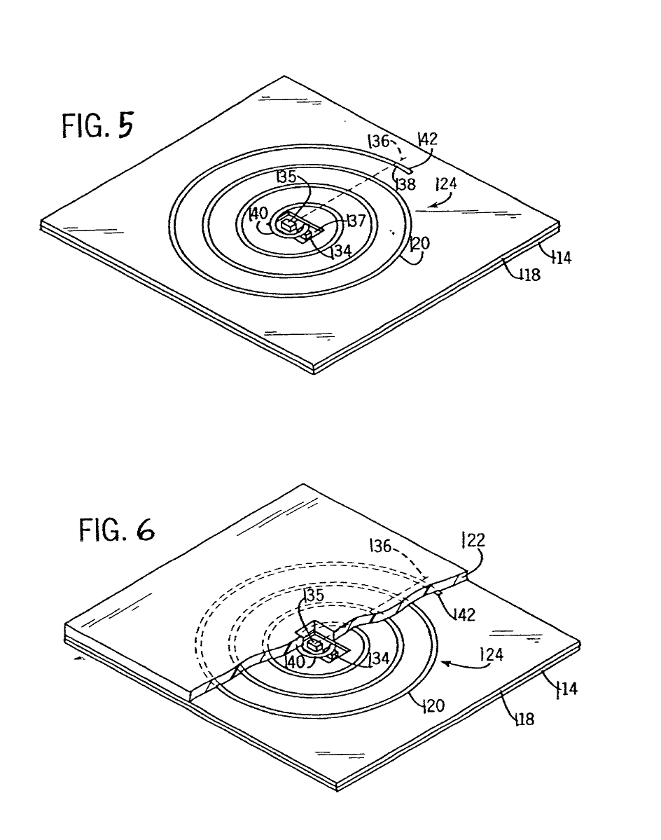

Referring to FIGS. 4 and 5, the third layer 118 is a dielectric material, such as Acheson Electrodag® 451SS available from Acheson Colloids Company, Port Huron, Mich. It is deposited within the label boundary and it has an annular shape which surrounds a small central area 137 containing the landing pads 134, 135. The central area 137 is thus not coated with the dielectric material 118. The area 137 is sized to accommodate the IC chip 130 which is mounted over and electrically connected to the landing pads 134, 135. A conductive via 138 for electrically connecting the cross over pass 136 to the fourth layer 120 is also formed by leaving a small portion of the cross over pass 136 uncoated by the dielectric material 118.

Looking particularly at FIG. 5, the fourth layer 120 may be a metallic conductive ink, such as used in the second layer 116. It is deposited onto the dielectric third layer 118 to form an antenna 124 in any of a variety of patterns depending upon the desired final configuration. In the illustrated embodiment, the antenna 124 is formed in a spiral pattern. The spiral antenna 124 has a plurality of rings including an inner ring 140 and an outer ring 142. The antenna inner ring 140 is electrically connected to one of the landing pads 134. The antenna outer ring 142 is deposited over the via 138 electrically connecting the antenna outer ring 142 to the other landing pad 135 through the cross over pass 136 without electrically contacting the other antenna rings. Although a spiral antenna is preferred and described herein, any suitable antenna shape may be used as will be appreciated by those of skill in the art.

As shown in FIG. 4, the fifth, spacer layer 122 is shaped substantially the same as the dielectric layer 118. It may be formed from an expandable material, such as a thermally expandable spacer ink comprising a binder of a polymeric resin system and an expandable additive, such as thermoplastic hollow spheres encapsulating a gas, or a blowing agent.

The additive may be thermally expandable, such as the thermoplastic hollow spheres, Expancel® 551DU, available from Expancel, Inc., Duluth, Ga. Although Expancel® 551DU is preferred, other expandable additives, such as Expancel® 091DU, Expancel® 461DU, or blowing agents may also be used. For example, blowing agents, such as diazoaminobenzene, azobis(isobutyronitrile), dinitroso pentamethylene tetramine, N,N′-dinitroso-N,N′-dimethylterephthalamide, azodicarbonamide, sulfonyl hydrazides, benzene sulfonyl hydrazide, p-toluene sulfonyl hydrazide, p,poxybis(benzene sulfonyl hydrazide), sulfonyl semicarbazides, decomposition products of p-toluene sulfonyl semicarbazide, esters of azodicarboxylic acid, and salts of azodicarboxylic acid are known in art and may be combined with the binder to form the spacer layer.

The polymeric resin system includes a resin and a solvent to provide a flexible vehicle which does not degrade upon expansion of the expandable additive. The resin is preferably a polyester, however it could also be a vinyl, ethylene vinyl acetate, acrylic, polyurethane, or a combination thereof, which is mixed with a compatible solvent, such as methyl ethyl ketone, toluene, cyclohexane, glycol ether, or the like.

Preferably, the fifth layer 22 is formulated, such that upon curing, it expands to a thickness substantially equal to the thickness of the epoxy encapsulated IC chip 30. For a chip height of approximately 0.35 mm, the expandable material preferably comprises no more than about 85% solvent, no more than about 30% resin, and no more than about 15% expandable additive. In one embodiment, the layer 22 comprises approximately 70% solvent, 23% resin, and 7% expandable additive. Typical chip heights range from approximately 0.25-0.9 mm and, of course, a different chip height may require a different combination of materials to provide the desired expansion of the expandable material. Although the expandable material preferably has a thickness substantially equal to the thickness of the encapsulated IC chip, any expandable material thickness greater or less than the IC chip height will provide some protection to the chip and may be used without departing from the scope of the invention. Depending upon the intended use environment, the fifth layer 22 can be omitted entirely, or made from a non-expandable layer having any desired thickness and an aperture therein to receive IC chip 30.

Following deposition of the spacer layer 22, the laminate article 10 is cured causing the layer 22 to expand. As shown in FIGS. 3, 4, 6, and 7, the expanded material surrounds the landing pads 34, 35 and defines a protective cavity 26 for receiving the IC chip 30 and an epoxy encapsulant 44. By providing the cavity 26 for the IC chip 30 and the encapsulant 44, the IC chip 30 does not form an exposed bump on the finished label 110. This may or may not be desirable, depending the particular contemplated design.

The IC chip 10 may be a flip chip having a memory and easily electrically connected to the landing pads 34 using conventional chip attachment methods. For example, once the protective cavity 26 is formed, a conductive adhesive, such as a needle dispensed polymeric conductive adhesive or an anisotropic conductive adhesive, is deposited into the cavity to electrically connect the chip 30 to each of the landing pads 34, 35. The IC chip 30 is then placed into the cavity 26 and encapsulated in the epoxy 44. The epoxy 44 deposited into the cavity 26 further protects the IC chip 30 and secures it in place. Although encapsulating the IC chip 30 with the epoxy 44 is described herein, encapsulating the chip is not required to practice the invention and in certain applications may not be desired.

One or more additional layers 28, such as a polymeric resin system comprising resins and solvents described above, may be deposited onto the fifth layer 22. The additional layers 28 may provide a layer which is compatible with thermal transfer, ink jet, or laser printing.

Alternatively, an overlaminate may be deposited on the spacer layer 22 or subsequent layers 28 to provide an adhesive surface to the laminate article 10. An overlaminate is a film, such as a polyester, cellulose acetate, vinyl, polyethylene, polypropylene, styrene, or the like, mixed with an adhesive, such as an acrylic or rubber.

Each layer 14, 16, 18, 20, and 22 may be formed using a silk screening process. The silk screening process may be a sheet fed operation or a roll to roll process. The sheet fed operation will result in sheets of multiple up labels or individual labels. The roll to roll process can supply rolls of labels in addition to sheet forms provided in the sheet fed method.

Deposition of layer material on the central area 37 around the landing pads 34, 35 is prevented by placing a releasable material, such as foam with a releasable adhesive, over the central area 37 during the silk screening process. Another method includes mounting the chip 30 prior to applying the expandable layer 22 and then notching the squeegee used in the silk screen printing process to avoid striking the chip 30.

Although silk screening may be preferred, other printing or deposition techniques, such as rotogravure, may also be used. Regardless of the particular technique chosen, the same process is preferably used to sequentially form each layer 14, 16, 18, 20, and 22 of the laminate article 10.

The RF-Key tags comprise, at a minimum, an antenna and a signal transforming device for generating a unique code in response to an interrogation signal. The tag may be either active, in which it further includes a battery or other power supply, or passive, in which it derives its power from the interrogation signal from the PDA.

At least two types of passive RF-Key tags may be used. The present invention is not limited to particular circuitry or transmission modalities, however, and other types of RF-Key devices may also be used as will be apparent to those of skill in the art in view of the disclosure herein. A first type of RF-Key includes an electronic circuit, e.g., CMOS, to store digital ID data which is then modulated onto a received signal by means of an RF circuit, e.g., a GaAs MESFET, transistor or controlled diode. Power for the data storage and modulating circuit may be derived from an interrogating RF beam or another power source, and power for the transmission itself is also derived from the beam. In this type of system, the interrogating RF beam is generally of fixed frequency, with the resulting modulated signal at the same or a different frequency, with AM, FM, PSK, QAM or another known modulation scheme employed. In order to provide separation between the received and transmitted signals, the modulated output may be, for example, a harmonic of the interrogating RF beam. Such a system is disclosed in U.S. Pat. No. 4,739,328, expressly incorporated herein by reference.

In one RF-Key interrogation system, an interrogation signal incorporates phase diversity, i.e., a phase which periodically switches between 0° and 90°, so that a null condition is not maintained for a period which would prevent RF-Key tag readout with a homodyne receiver. See, U.S. Pat. No. 3,984,835, incorporated herein by reference.

Another system, described in U.S. Pat. No. 4,888,591, incorporated herein by reference, discloses a semiconductor memory tag which is interrogated with a direct sequence spread spectrum signal, which allows discrimination of received signals based on signal return delay. By employing a direct sequence spread spectrum having a decreasing correlation of a return signal with the interrogation signal as delay increases, more distant signals may be selectively filtered. This system employs a homodyne detection technique with a dual balanced mixer.

A second type of RF-Key tag includes a surface acoustic wave device, in which an identification code is provided as a characteristic time-domain reflection pattern in a retransmitted signal, in a system which generally requires that the signal emitted from an exciting antenna be non-stationary with respect to a signal received from the tag. This ensures that the reflected signal pattern is distinguished from the emitted signal. In such a device, received RF energy, possibly with harmonic conversion, is emitted onto a piezoelectric substrate as an acoustic wave with a first interdigital electrode system, from which it travels through the substrate, interacting with reflector elements in the path of the wave, and a portion of the acoustic wave is ultimately received by the interdigital electrode system and retransmitted. These devices do not require a semiconductor memory. The propagation velocity of an acoustic wave in a surface acoustic wave device is slow as compared to the free space propagation velocity of a radio wave. Thus, assuming that the time for transmission between the radio frequency interrogation system is short as compared to the acoustic delay, the interrogation frequency should change such that a return signal having a minimum delay may be distinguished, and the interrogation frequency should not return to that frequency for a period longer than the maximum acoustic delay period. Generally, such systems are interrogated with a pulse transmitter or chirp frequency system.

Systems for interrogating a passive transponder employing acoustic wave devices, carrying amplitude and/or phase-encoded information are disclosed in, for example, U.S. Pat. Nos. 4,059,831; 4,484,160; 4,604,623; 4,605,929; 4,620,191; 4,623,890; 4,625,207; 4,625,208; 4,703,327; 4,724,443; 4,725,841; 4,734,698; 4,737,789; 4,737,790; 4,951,057; 5,095,240; and 5,182,570, expressly incorporated herein by reference. The tags interact with an interrogator/receiver apparatus which transmits a first signal to, and receives a second signal from the remote transponder, generally as a radio wave signal. The transponder thus modifies the interrogation signal and emits encoded information which is received by the interrogator/receiver apparatus.

Other passive interrogator label systems are disclosed in U.S. Pat. Nos. 3,273,146; 3,706,094; 3,755,803; and 4,058,217, expressly incorporated herein by reference. In its simplest form, the systems disclosed in these patents include a radio frequency transmitter capable of transmitting RF pulses of electromagnetic energy. These pulses are received at the antenna of a passive transponder and applied to a piezoelectric “launch” transducer adapted to convert the electrical energy received from the antenna into acoustic wave energy in the piezoelectric material. Upon receipt of a pulse, an acoustic wave is generated within the piezoelectric material and transmitted along a defined acoustic path. This acoustic wave may be modified along its path, such as by reflection, attenuation, variable delay, and interaction with other transducers.

When an acoustic wave pulse is reconverted into an electrical signal it is supplied to an antenna on the transponder and transmitted as RF electromagnetic energy. This energy is received at a receiver and decoder, preferably at the same location as the interrogating transmitter, and the information contained in this response to an interrogation is decoded. The tag typically has but a single antenna, used for both receiving the interrogation pulse and emitting an information bearing signal.

In general, the overall passive interrogator label system includes an “interrogator” for transmitting a first radio frequency signal; at least one transponder which receives this first signal, processes it and sends back a second radio frequency signal containing encoded information; and a receiver, normally positioned proximate to or integrated with the interrogator, for receiving the second signal and decoding the transponder-encoded information.

Separate interrogation systems may be configured to operate in close proximity, for example by employing directional antennas and employing encoded transmissions, such as a direct sequence spread spectrum signal, which has reduced self-correlation as relative delay increases, thus differentiating more distant signals. The encoded information may be retrieved by a single interrogation cycle, representing the state of the tag, or obtained as an inherent temporal signature of an emitted signal due to internal time delays.

In the acoustic wave tags described above, the interrogator transmits a first signal having a first frequency that successively assumes a plurality of frequency values within a prescribed frequency range. This first frequency may, for example, be in the range of 905-925 MHz, referred to herein as the nominal 915 MHz band, a frequency band that may be available. The response of the tag to excitation at any given frequency is distinguishable from the response at other frequencies. Further, because the frequency changes over time, the received response of the tag, delayed due to the internal structures, may be at a different frequency than the simultaneously emitted signal, thus reducing interference.

Passive transponder encoding schemes include control over interrogation signal transfer function H(s), including the delay functions f(z). These functions therefore typically generate a return signal in the same band as the interrogation signal. Since the return signal is mixed with the interrogation signal, the difference between the two will generally define the information signal, along with possible interference and noise. By controlling the rate of change of the interrogation signal frequency with respect to a maximum round trip propagation delay, including internal delay, as well as possible Doppler shift, the maximum bandwidth of the demodulated signal may be controlled.

The following references are hereby expressly incorporated by reference for their disclosure of RF modulation techniques, transponder systems, information encoding schemes, transponder antenna and transceiver systems, excitation/interrogation systems, and applications of such systems: U.S. Pat. Nos. 2,193,102; 2,602,160; 2,774,060; 2,943,189; 2,986,631; 3,025,516; 3,090,042; 3,206,746; 3,270,338; 3,283,260; 3,379,992; 3,412,334; 3,480,951; 3,480,952; 3,500,399; 3,518,415; 3,566,315; 3,602,881; 3,631,484; 3,632,876; 3,699,479; 3,713,148; 3,718,899; 3,728,632; 3,754,250; 3,798,641; 3,798,642; 3,801,911; 3,839,717; 3,859,624; 3,878,528; 3,887,925; 3,914,762; 3,927,389; 3,938,146; 3,944,928; 3,964,024; 3,980,960; 3,984,835; 4,001,834; 4,019,181; 4,038,653; 4,042,906; 4,067,016; 4,068,211; 4,068,232; 4,069,472; 4,075,632; 4,086,504; 4,114,151; 4,123,754; 4,135,191; 4,169,264; 4,197,502; 4,207,518; 4,209,785; 4,218,680; 4,242,661; 4,287,596; 4,298,878; 4,303,904; 4,313,118; 4,322,686; 4,328,495; 4,333,078; 4,338,587; 4,345,253; 4,358,765; 4,360,810; 4,364,043; 4,370,653; 4,370,653; 4,388,524; 4,390,880; 4,471,216; 4,472,717; 4,473,851; 4,498,085; 4,546,241; 4,549,075; 4,550,444; 4,551,725; 4,555,618; 4,573,056; 4,599,736; 4,604,622; 4,605,012; 4,617,677; 4,627,075; 4,641,374; 4,647,849; 4,654,512; 4,658,263; 4,739,328; 4,740,792; 4,759,063; 4,782,345; 4,786,907; 4,791,283; 4,795,898; 4,798,322; 4,799,059; 4,816,839; 4,835,377; 4,849,615; 4,853,705; 4,864,158; 4,870,419; 4,870,604; 4,877,501; 4,888,591; 4,912,471; 4,926,480; 4,937,581; 4,951,049; 4,955,038; 4,999,636; 5,030,807; 5,055,659; 5,086,389; 5,109,152; 5,131,039; 5,144,553; 5,163,098; 5,193,114; 5,193,210; 5,310,999; 5,479,160; 5,485,520 and 6,107,910.

Although the present invention has been described in terms of certain preferred embodiments, other embodiments will become apparent to those of ordinary skill in the art in view of the disclosure herein. Accordingly, the present invention is intended to be limited not by the specific disclosures herein, but solely by reference to the attached claims.

What is claimed is:

1. A method of enabling a portable electronic device, comprising the steps of:
transmitting an interrogation signal from the electronic device;
receiving the interrogation signal at an electronic key which is remote from the device;
transmitting a password from the key in response to receipt of the interrogation signal; and
enabling the device in response to receipt of the password.

2. A method of enabling a portable electronic device as in claim 1, wherein the device comprises a cellular telephone.

3. A method of enabling a portable electronic device as in claim 1, wherein the device comprises a PDA.

4. A method of enabling a portable electronic device as in claim 1, wherein the device comprises a portable computer.

5. A method of enabling a portable electronic device as in claim 1, wherein the interrogation signal comprises an RF signal.

6. A method of enabling a portable electronic device as in claim 5, wherein the password comprises a modified form of the interrogation signal.

7. A method of enabling a portable electronic device as in claim 1, wherein the key comprises an RF-ID circuit.

8. A method of enabling a portable electronic device as in claim 7, wherein the RF-ID circuit is passive.

9. A method of enabling a portable electronic device as in claim 7, wherein the RF-ID circuit is active.

10. A method of enabling a portable electronic device as in claim 7, wherein the transmitting an interrogation signal step is in response to turning power on to the device.

11. A method of enabling a portable electronic device as in claim 7, wherein the transmitting an interrogation signal step comprises transmitting a single pulse of predetermined duration.

12. A method of enabling a portable electronic device as in claim 7, wherein the enabling step comprises enabling at least one function on the device.

13. A method of enabling a portable electronic device as in claim 1, wherein the receiving step comprises receiving the interrogation signal within about six feet from the device.

14. A method of enabling a portable electronic device as in claim 13, wherein the receiving step comprises receiving the interrogation signal within about three feet from the device.

15. A method of enabling a portable electronic device as in claim 14, wherein the receiving step comprises receiving the interrogation signal within about eighteen inches from the device.

16. A portable electronic device security system, comprising:
a portable electronic device;
an interrogation signal transmitter associated with the device;
an electronic key remote from the device; and
a password encoded in the key;
wherein the key transmits the password in response to an interrogation signal from the device, and the device is enabled in response to receipt of the password.

17. A portable electronic device security system as in claim 16, wherein the portable electronic device comprises a cellular telephone.

18. A portable electronic device security system as in claim 16, wherein the portable electronic device comprises a PDA.

19. A portable electronic device security system as in claim 16, wherein the portable electronic device comprises a computer.

20. A portable electronic device security system as in claim 16, wherein the key comprises a passive RF-Key circuit.

21. A portable electronic device security system as in claim 16, wherein the key comprises an active RF-Key circuit

22. A portable electronic device security system as in claim 16, wherein the key is carried by an article of clothing.

23. A portable electronic device security system as in claim 16, wherein the key is carried by a wrist band.

24. A portable electronic device security system as in claim 23, wherein the wrist band comprises a wrist watch strap.

25. A portable electronic device security system as in claim 16, wherein the key is carried by a wrist watch.

26. A portable electronic device security system as in claim 16, wherein the key is carried by a pair of eyeglasses.

27. A portable electronic device security system as in claim 16, wherein the key is carried by a finger ring.

28. A portable electronic device security system as in claim 16, wherein the key is carried by a glove.

29. A portable electronic device security system as in claim 16, wherein the interrogation signal comprises an RF signal.

30. A portable electronic device security system as in claim 16, wherein the key carries a password for each of two or more electronic devices.

31. A wireless personal preference control system, comprising an RF-Key circuit including an antenna, a memory and at least one preference password therein; a receiver, remote from the RF-Key; and electronics in communication with the receiver for identifying the password and executing a preference in response to receipt of the password by the receiver.
